(19) United States
(12) Patent Application Publication
(10) Pub. No.: US 2011/0140652 A1
(43) Pub. Date: Jun. 16, 2011

(54) Charging Apparatus for Electronic Devices

(75) Inventor: Murali Chandran, Raffles Place (SG)

(73) Assignee: AGREENC PTE LTD, One Raffles Place (SG)

(21) Appl. No.: 13/058,833

(22) PCT Filed: Jun. 28, 2010
(86) PCT No.: PCT/SG2010/000241

§ 371 Date: Feb. 11, 2011

(30) Foreign Application Priority Data
Jul. 1, 2009 (SG) 200904467-8

(51) Int. Cl. H02J 7/00

(52) U.S. Cl. 320/107

(57) ABSTRACT

The present invention provides a smart charging apparatus that mediates an electronic transaction between the Portable Electronic Device (PED) and a gadget and allows PED recognition by the gadget and also provides a provision for opting between a data transfer mode or a charging mode, wherein a PED can be charged at active, standby or sleep mode of the gadget.

### FIELD OF THE INVENTION

The present invention relates to a smart and multifunctional charging apparatus for portable electronic devices.

### BACKGROUND TO THE INVENTION

Portable electronic devices (PEDs) such as PDAs, MP3 players or mobile phones are generally charged using specially configured charging adapters. These adapters are configured to be plugged into conventional wall plug(s) to obtain electrical charging input. Further, many of these charging apparatus are PED specific. For example, the charging apparatus adapted for a mobile phone may not be used to charge a PDA or MP3 player. This invariably inconveniences a person who has a plurality of different types of PEDs as he/she will be required to carry different charging apparatus for charging different types of PEDs when the need arises. Alternatively, PEDs may draw electrical power from specific ports on personal computers (PCs) for the purposes of charging. The specific ports include the Universal Serial Bus (USB) and its variants (i.e. micro and mini USBs). The PEDs are typically attached to the USB port(s) via charging cables. When the PC is switched on, the charging cables provide electrical input to the PEDs at typically 5V and charging may begin after a data exchange with the PC. However, when the PC is switched off or in ‘stand-by’ mode, the charging cable is able to provide electrical input to the PEDs but will not be able to charge the PED because the data exchange cannot take place. This translates into electricity wastage in situations where the PC must be switched on but is not required to be used for any other purposes except charging.

To mitigate the above, charging apparatus that do not require the PC to be switched on when charging the PEDs are developed. In this regard, the applicant has identified that iGo, Inc's USB charging cable does not require the PC to be switched on but are able to charge the electronic portable devices when the PC is in ‘standby’ mode. The iGo USB charging cable charges from a PC in standby mode if the following condition is fulfilled, i.e., the PC is configured such that the V_{bus} power for the USB electrically connected is to be switched on.

In addition, the tip connector of the iGo USB charging cable may be switched according to the type of PED to be charged, thus enabling the USB charging cable to charge different PEDs using one charging apparatus. For example, a blackberry PDA and Apple iPod may be charged using the same iGo USB charging cable by switching the tip connector.

Although the iGo charging apparatus allows multiple devices to be charged in the PC ‘standby’ mode, it has multiple drawbacks. For example, the tip connector of the device has to be changed for charging different types of PED. Due to the small size of the small tip connectors, they may be easily misplaced/lost.

The charging apparatus and its cable described above does not allow data synchronization and has to be replaced to a regular data cable should the need for data transfer/synchronization arise. This poses further inconvenience to the user.

Most of the USB chargers that are available at present require installation of some software or some kind of alteration in the configuration of a computer that allows the computing machine to recognize a PED connected to it. This also means that charging of only a specific PED, whose compatible software has been pre-installed on a particular PC can take place as a combination. Same PED cannot be charged on another PC.

### SUMMARY OF THE INVENTION

The present invention provides a charging apparatus for portable electronic devices. The charging apparatus is particularly suited, but not limited for charging portable electronic devices such as mobile phones, MP3 players and Personal Digital Assistants (PDAs) via a USB slot, wall adapter or car charger.

One aspect of the present invention provides a smart charging apparatus that mediates an electronic transaction between the Portable Electronic Device (PED) and a gadget and allows PED recognition by the gadget and also provides a provision for opting between a data transfer mode or a charging mode, wherein a PED can be charged at active, standby or sleep mode of the gadget.

One aspect of the present invention provides an apparatus comprising: at least one USB adapter, the USB adapter being configured to be electrically connected to a USB port of a gadget; at least one charging adapter, the charging adapter configured to be electrically connected to a Portable Electronic Device (PED); at least one internal switch and at least one manual switch; wherein the apparatus is a smart apparatus which recognizes a portable electronic device electrically connected to it without alteration or installation of a software or hardware component of the gadget for device recognition.

One aspect of the present invention provides a method of Portable Electronic Device (PED) recognition by a power source, the method comprising mediating an electronic transaction between the PED and the power source, by a charging apparatus, wherein the charging apparatus comprises: at least one USB adapter, the USB adapter being configured to be electrically connected to a USB port of a power source; at least one charging adapter, the charging adapter configured to be electrically connected to a portable electronic device; at least one internal switch and at least one manual switch; wherein the power source has a USB output. Another aspect of the present invention provides a wall power charging apparatus comprising: a wall adapter that can charge at least two devices sequentially; at least two charging adapters, the charging adapter configured to be electrically connected to the Portable Electronic Device (PED).

### BRIEF DESCRIPTION OF THE DRAWINGS

The following invention will be described with reference to the following drawings of which:

FIG. 1a shows the block diagram of the charging apparatus.

FIG. 1b shows a variant of the charging apparatus adapted for use for Apple Y-adapters and micro USB adapters/mini-USB adapters.

FIG. 1c shows a variant of the charging apparatus adapted for use for Apple Y-adapters and micro USB adapters/mini-USB adapters, where the Y connector is connected to a wall adapter thus allowing both the Apple and mini-USB adapters to use the same cable eliminating multiple cables.

FIG. 2 shows the circuit diagram of the integrated charging and data circuitry.

FIGS. 3a and 3b show perspective views of the charging apparatus, FIG. 3c shows the manual switch, FIG. 3d shows the apparatus case and FIG. 3e shows the bottom case.

FIGS. 4a, 4b and 4c, 4d show variants of the embodiment of the invention adapted for use for Apple Y-adapters, micro USB adapters, and mini-USB adapters. FIGS. 4e, 4f and 4g show variants of the embodiment of the invention adapted for use for a single USB adapter such as Apple, micro-USB and mini-USB.

Other arrangements of the invention are possible and, consequently, the accompanying drawings are not to be understood as superseding the generality of the preceding description of the invention.

### DETAILED DESCRIPTION OF THE INVENTION

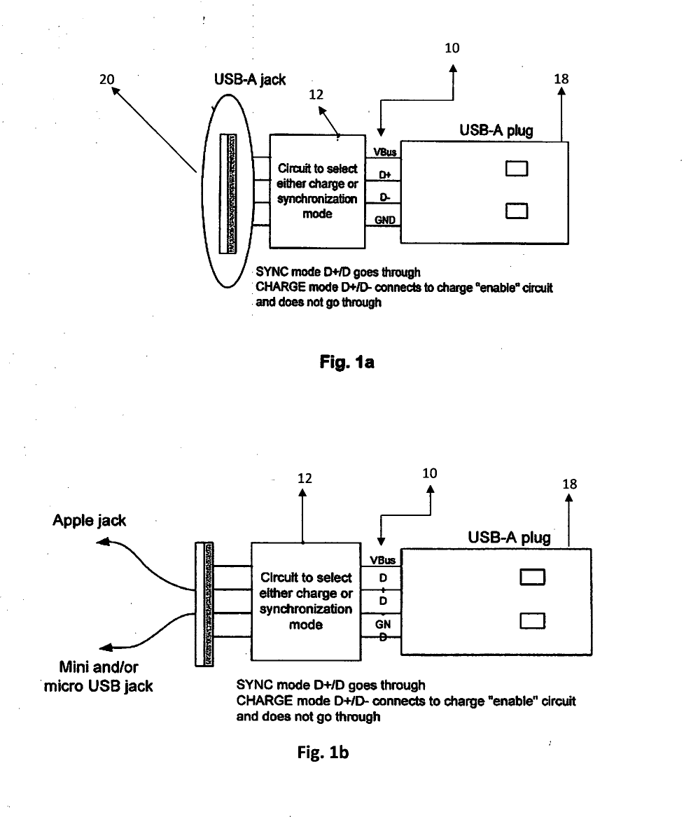

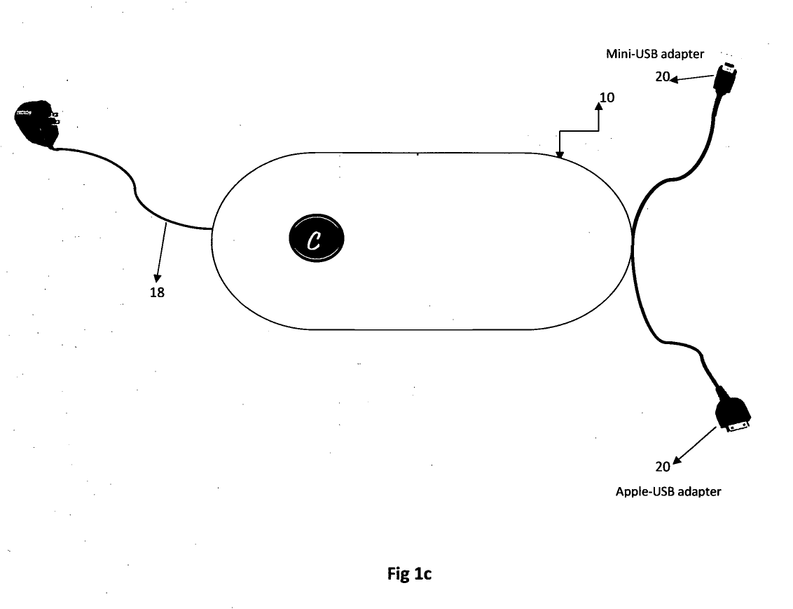

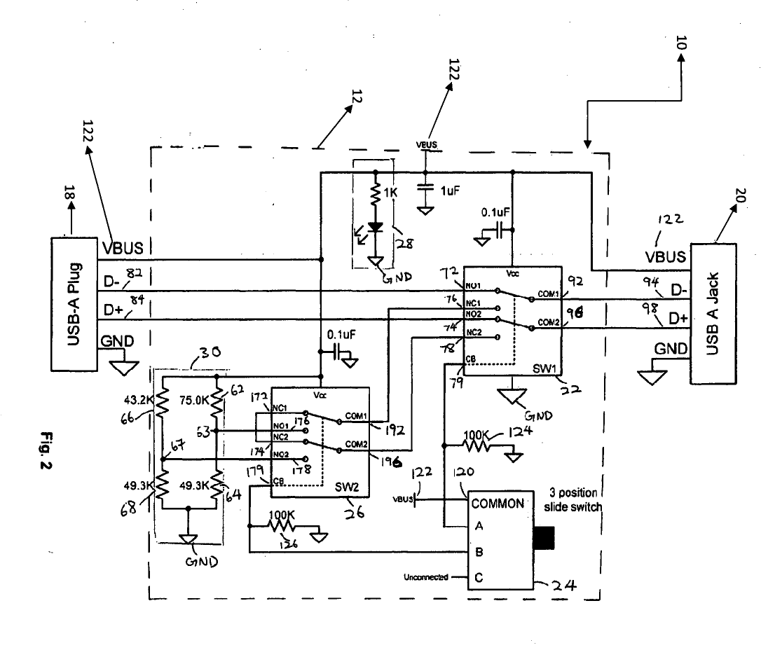

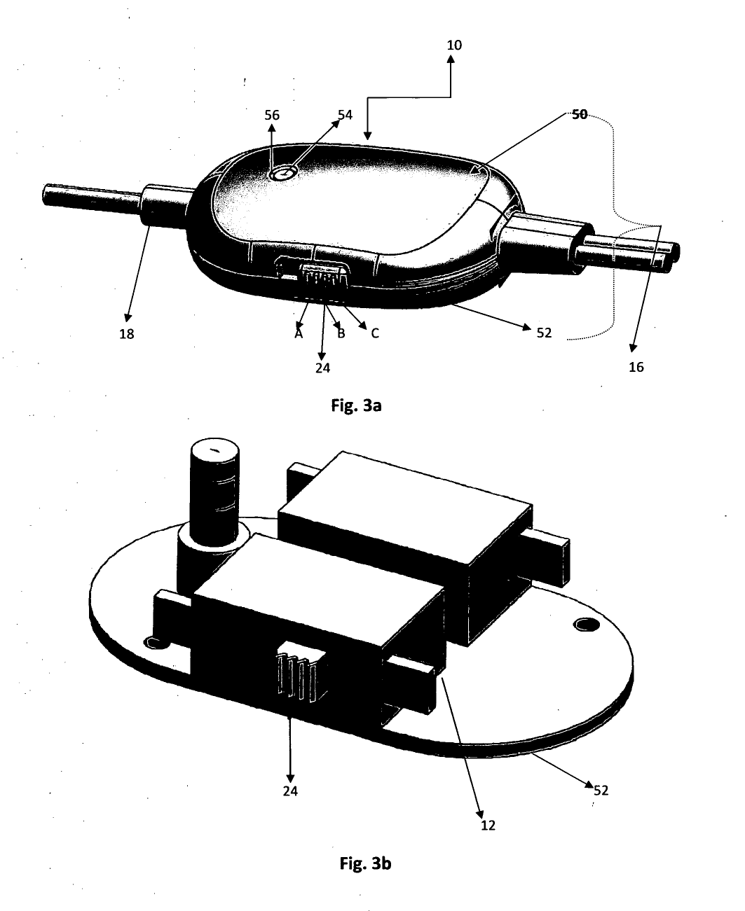

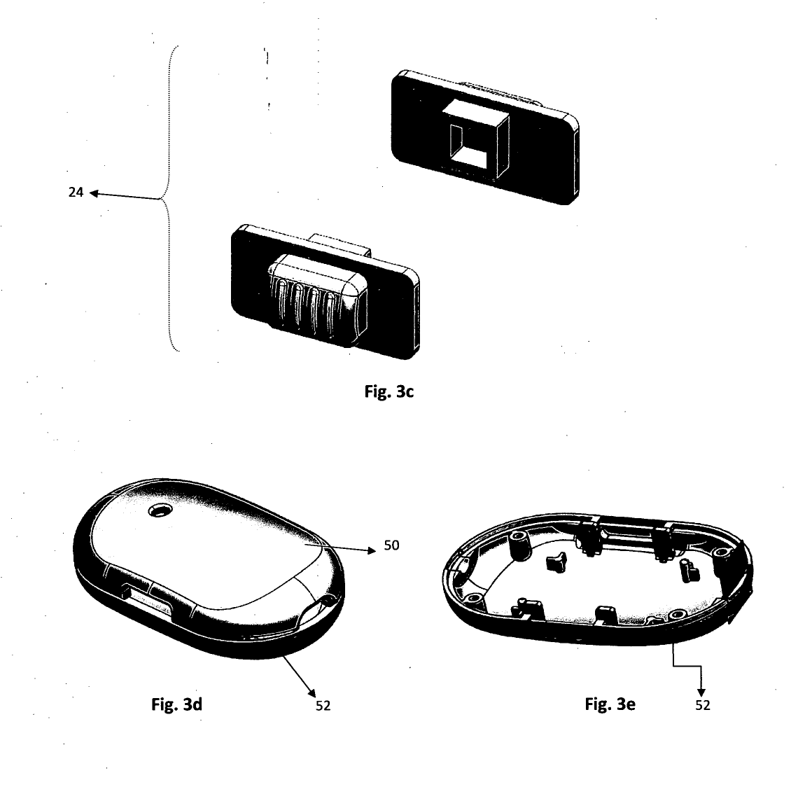

In accordance with an embodiment of the invention there is charging apparatus 10. The charging apparatus 10 comprises a charging and data circuit 12, outer casing 16, USB type-A plug 18 and USB type-A jack 20 as shown in FIG. 1 and FIG. 3.

One embodiment of the present invention provides a charging apparatus for portable electronic devices comprising:

at least one USB adapter, the USB adapter being configured to be electrically connected to a USB port of a gadget;
at least one charging adapter, the charging adapter configured to be electrically connected to a portable electronic device;
at least one internal switch and at least one manual switch;
wherein the apparatus is a smart apparatus which recognizes a portable electronic device electrically connected to it without alteration or installation of a software or hardware component of the gadget for device recognition.

Another embodiment of the present invention provides a charging apparatus, wherein the gadget is a machine having power and a USB port.

Another embodiment of the present invention provides a charging apparatus, wherein the gadget is a computing machine.

Another embodiment of the present invention provides a charging apparatus, wherein the at least one internal switch is configured such that it switches between at least one charging mode and a data transfer mode according to the position of the manual switch.

Another embodiment of the present invention provides a charging apparatus, wherein the apparatus charges the portable electronic device at active or standby mode of the gadget.

Another embodiment of the present invention provides a charging apparatus, wherein the apparatus charges one portable electronic device at a time.

The term ‘Portable Electronic Device’ (PED) as used in the present invention includes but is not limited to cell phone, a personal digital assistant, iPad, digital camera, digital camcorder, music player, iPOD, global positioning system, bluetooth headset, wall adapter, car charger, cordless speaker and the like.

Another embodiment of the present invention provides a charging apparatus, wherein method of charging the electronic device via the apparatus comprises: generating a charger output having a regulated voltage and a maximum current capacity; generating a charger configuration signal having pre-selected characteristics, the characteristics including a pre-selected voltage level or shorting of connections; and coupling the charger output and charger configuration signal to the electronic device via a Universal Serial Bus (USB) port on the electronic device, wherein the electronic device is configured to identify the values of the regulated voltage and maximum current capacity of the charger output from the pre-selected voltage level or shorting of connections of the charger configuration signal and to apply the charger output to recharge the rechargeable power source.

A yet another embodiment of the present invention provides a charging apparatus that allows charging of a PED from any gadget having power and a USB port.

One embodiment of the present invention provides a multifunction single USB cable that allows charging of at least two devices sequentially from any USB port of a computing machine and/or data sync between the PED and the computing machine.

An embodiment of the present invention allows a user to charge their portable device from any USB port without the need of configuration or pre-installation of software. A traveler would only need to carry one cable which functions as a charger and data cable which dispenses the requirement of carrying a wall adapter as a PC USB port is always close at hand.

One embodiment of the present invention provides PED recognition by the gadget electrically connected to it via the charging apparatus by allowing exchange of digital signatures between the gadget and the apparatus. Another embodiment of the present invention provides PED recognition by the computing machine electrically connected to it via the charging apparatus by allowing exchange of digital signatures between the computing machine and the apparatus.

One embodiment of the present invention provides a method of Portable Electronic Device (PED) recognition by a power source, the method comprising mediating an electronic transaction between the PED and the power source, by a charging apparatus, wherein the charging apparatus comprises:

at least one USB adapter, the USB adapter being configured to be electrically connected to a USB port of a power source; at least one charging adapter, the charging adapter configured to be electrically connected to a portable electronic device; at last one internal switch and at least one manual switch; wherein the power source has a USB output.

Another embodiment of the present invention provides a method of PED recognition by a gadget, the method comprising mediating an electronic transaction between the PED and the gadget, by a charging apparatus, wherein the charging apparatus comprises: at least one USB adapter, the USB adapter being configured to be electrically connected to a USB port of a gadget; at least one charging adapter, the charging adapter configured to be electrically connected to a portable electronic device; at least one internal switch and at least one manual switch; wherein the gadget has a USB output.

Another embodiment of the present invention provides a method of PED recognition by a computing machine, the method comprising mediating an electronic transaction between the PED and the computing machine, by a charging apparatus, wherein the charging apparatus comprises: at least one USB adapter, the USB adapter being configured to be electrically connected to a USB port of a computing machine; at least one charging adapter, the charging adapter configured to be electrically connected to a portable electronic device; at least one internal switch and at least one manual switch; wherein the computing machine has a USB output.

Another embodiment of the present invention provides charging of a PED by the charging apparatus of the present invention, wherein the charging starts once the switch position is selected indicating which PED needs to be charged, this enables a single PED to be charged at a time, thereby avoiding the USB power shut down by accidently connecting two devices at a time. This is also a safe method to charge different PEDs without compromising on the safety of the computing machine.

A yet another embodiment of the present invention allows sequential charging of at least two PEDs electrically connected to a power source having a USB output.

One embodiment of the present invention provides a wall power charging apparatus comprising: a wall adapter that can charge at least two devices sequentially; at least two charging adapters, the charging adapter configured to be electrically connected to the Portable Electronic Device (PED).

One embodiment of the present invention provides a wall power charging apparatus, wherein the wall charger has at least one internal switch and at least one manual switch.

One embodiment of the present invention provides a wall power charging apparatus, wherein the wall charger charges one device at a time.

One embodiment of the present invention provides a wall power charging apparatus, wherein the wall charger provides emulation between the functions of the internal switch.

Another embodiment of the present invention provides an eco-friendly charging apparatus that allows a portable device to be charged from the computing machine's USB port even if the machine is in standby or hibernating mode. This dispenses the requirement to keep the computing machine in a full power-on mode, thereby reducing the power consumption. This also prevents reduction of life of various hardware components and battery of the machine by allowing charging at the standby mode.

Another embodiment of the present invention provides protection of the computing machine from the network security threats while charging of PED, by allowing charging of the PED when computing machine is at the standby mode.

Another embodiment of the present invention provides a smart charging apparatus that makes the PED electrically connected to it, recognizable by the computing machine.

Another embodiment of the present invention provides a device where the USB jack that plugs into the USB port may be replaced by a wall plug and the device selector switch may be removed so that when plugged into a wall, both devices on the Y cable can charge sequentially.

The charging and data circuit 12 comprises two Double pole, Double throw (DPDT) switch 22, 26, a manual switch 24, an LED circuitry 28, and a resistor bias network 30 as shown in FIG. 2.

The DPDT switch 22, 26 are typically FSUSB30MUX Low Power 2-Port HiSpeed USB 2.0 (480 Mbps) Integrated Circuit Switch, of which the datasheet is publicly available. The DPDT switch 22, 26 are designed to minimize electrical current consumption even when the control voltage applied to a pin CB is lower than the supply voltage (V_{cc}). Such design is suited for the embodiment as it is suited for portable applications such as mobile phones, allowing for direct interface with the General Purpose inputs/outputs (I/Os) of a baseband processor. The electrical input V_{cc} supplied to the DPDT switch 22, 26 are typically maintained at about 4.3V to 5V. Capacitor(s) 32 may be electrically connected in parallel to the electrical input V_{cc} to provide a stable voltage input to the DPDT switches 22, 26 as configured by a person skilled in the art.

The pin configurations/connections of the DPDT switch 22, 26 will be described in turn.

The relevant pins of the DPDT switch 22 used for this embodiment are electrically connected as follows:

The pin NO1 72 is electrically connected to pin D⁻ 82 of the USB type-A plug 18

The pin NO2 74 is electrically connected to pin D⁺ 84 of the USB type-A plug 18

The pin NC1 76 is electrically connected to pin COM1 192 of the DPDT switch 26

The pin NC2 78 is electrically connected to pin COM2 196 of the DPDT switch 26

The pin CB 79 is electrically connected to the pin A of the manual switch 24

The GND and OE pins (not shown) are electrically connected together and electrically grounded. This ensures that the OE pin for DPDT switch 22 is always at a ‘Low’ state.

The pin COM1 92 of the DPDT switch 22 is electrically connected to the pin D− 94 of the USB type-A jack 20.

The pin COM2 96 is electrically connected to the pin D⁺ 98 of the USB type-A jack 20.

The relevant pins of the DPDT switch 26 used for this embodiment are electrically connected as follows:

The pin NC1 172 is electrically connected to pin NC2 174 of the same DPDT switch 26.

The pin NO1 176 is electrically connected to a point 63 of the resistor bias network 30. Point 63 is between a first resistor 62 and a second resistor 64.

The pin NO2 178 is electrically connected to a point 67 of the resistor bias network 30. Pin 67 is between a third resistor 66 and a forth resistor 68.

The pin CB 179 of the DPDT switch 26 is electrically connected to the pin B of the manual switch 24.

The GND and pin OE (not shown) are electrically connected together and electrically grounded. This ensures that the OE pin for DPDT switch 26 is always at a ‘Low’ state.

The manual switch 24 is typically a three position slide switch. In the context of this embodiment, there are three different positions of the manual switch 24 labeled A, B, C.

Position A is selected by a user for common data transfer/synchronization.

Position B is selected by the user for charging Apple Devices such as IPod;

Position C is selected by the user for charging other devices.

As an example of the operation of this embodiment, position C is selected by the user for purposes of charging a blackberry PDA.

As the manual switch 24 slides to a position corresponding to each selected position A, B or C, each of the three pins A, Band C will be electrically connected (Le. shorted) to a ‘common’ pin 120 respectively. The common pin 120 is electrically connected to a V_{bus} source 122. The V_{bus} source 122 typically outputs about 5V. In addition, each pin of the manual switch 24 is electrically connected as follows:

Pin A is electrically connected to the pin CB 79 of the DPDT switch 22. A resistor 124 of with resistance value of about 100 k (or other values as chosen appropriately by a person skilled in the art) may be electrically connected in parallel to the connection between pin A and pin CB to pull down the voltage at the CB pin when the manual switch is not connect to position A.

Pin B is electrically connected to pin CB 179 of the DPDT switch 26. A resistor 126 of resistance value of about 100 k (or other values as chosen appropriately by a person skilled in the art) may be electrically connected in parallel to the connection between pin B and pin CB to pull down the voltage at the CB pin when the manual switch is not connect to position B.

Pin C is un-connected to any other elements.

The outer casing 16 forms a protective covering for the charging and data circuitry 12. The outer casing 16 comprises a top portion 50 and a bottom portion 52.

The top portion 50 comprises a transparent portion 54. The transparent portion 54 is positioned such that it corresponds to the position of the LED 28 as implemented on Printed Circuit Board (not shown). To enhance the illuminating effect of the LED 28, the transparent portion 54 may be surrounded by a black circle silk screen 56. The top portion 50 and bottom portion 52 of the outer casing 16 may be attached by any means as known to a person skilled in the art and will not be further elaborated.

The operation in accordance with the embodiment is highlighted as follows:

The USB type-A Plug 18 is electrically connected to a USB port of a PC. The PC may be, but is not limited to, a desktop or a laptop. The PC can either be switched on or at the ‘standby’ state. At this state, the V_{Bus} of the USB port of the PC provides an approximately constant 5V DC supply to the pin V_{Bus} 122 USB type-A Plug 18.

In order to charge an Apple device (e.g. an iPod), the user connects the iPod device to the USB type-A jack 20 and selects the option to charge the iPod by sliding the manual switch 24 to position B. At the position B:
An electrical connection is established between the common pin 120 and the pin B of the manual switch 24.
At the DPDT switch 22, the voltage at pin CB is at a ‘Low’ state (approximately at voltage of 0 or GND) and the OE pin is at a ‘Low’ state. This causes the pin NC2 78 and pin NC 1 76 of the DPDT switch 22 to be electrically connected to the pin COM2 D+ 96, 98 and pin COM1 D− 92, 94 respectively.
At the DPDT switch 26, the voltage at pin CB is at a ‘High’ state and the OE pin is at a ‘Low’ state. This causes the NO1 pin 176 and NO2 pin 178 to be electrically connected to the pin COM1 192 and pin COM2 196 respectively.
As a consequence, the voltage at pin 94 is approximately the voltage at point 63 of the resistor bias network 30, and the voltage at pin 96 is approximately the voltage at point 67 of the resistor bias network 30.

This fulfills the charging requirements for the iPod device, i.e., the D+ and D− pins of the iPod device requires a midpoint voltage input as provided by the resistor bias network 30.

In order to charge a Blackberry PDA device; the user connects the blackberry to the USB type-A jack 20 and selects the option to charge the blackberry by sliding the manual switch 24 to position C. At the position C:
An electrical connection is established between the common pin 120 and the pin C of the manual switch 24. However, no further connections are made at position C.
At the DPDT switch 22, the voltage at pin CB is at the ‘Low State’. This causes the NC1 pin 76 and NC2 pin 78 to be electrically connected to the pin COM1 92 and pin COM2 96 respectively.
At the DPDT switch 26, the voltage at pin CB is at the ‘Low State’. This causes the pin NC1 172 and pin NC2 174 to be electrically connected to the pin COM1 192 and pin COM2 196 respectively.
As the pin NC1 172 and pin NC2 174 are electrically connected together, the voltage at pin 92, 94, 96, and 98 are approximately the same.

This fulfills the charging requirements for the blackberry device, i.e., the D+ and D− pins of the blackberry device requires the voltage at pin COM1 92 and pin COM2 96 to be approximately the same.

In order to use the charging apparatus 10 for synchronization or transfer of data, the user connects the device (regardless of whether iPod or Blackberry) to the USB type-A jack 20 and selects the option to transfer/synchronize data by sliding the manual switch 24 to position A. At the position A:
An electrical connection is established between the common pin 120 and pin A of the manual switch 24.
At the DPDT switch 22, the voltage at pin CB is at the ‘High State’. This causes the NO1 pin 72 and NO2 pin 74 to be electrically connected to the pin COM1 92 and pin COM2 96 respectively.
As a consequence, the pin D+ 84 and pin D− 82 are electrically connected to the pin D+ 98 and pin D− 94 respectively.

Data transfer/synchronization can then proceed as the pin D+ 84 and pin D− 82 pin is in electrical connection with pin 98 and pin 94 respectively.

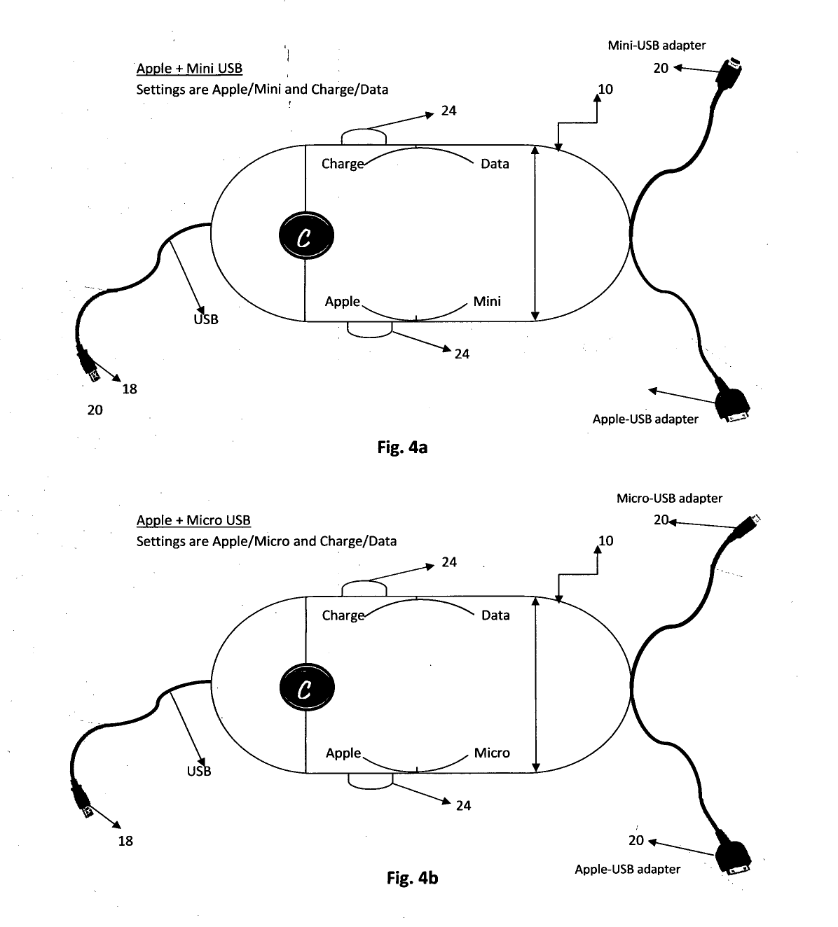

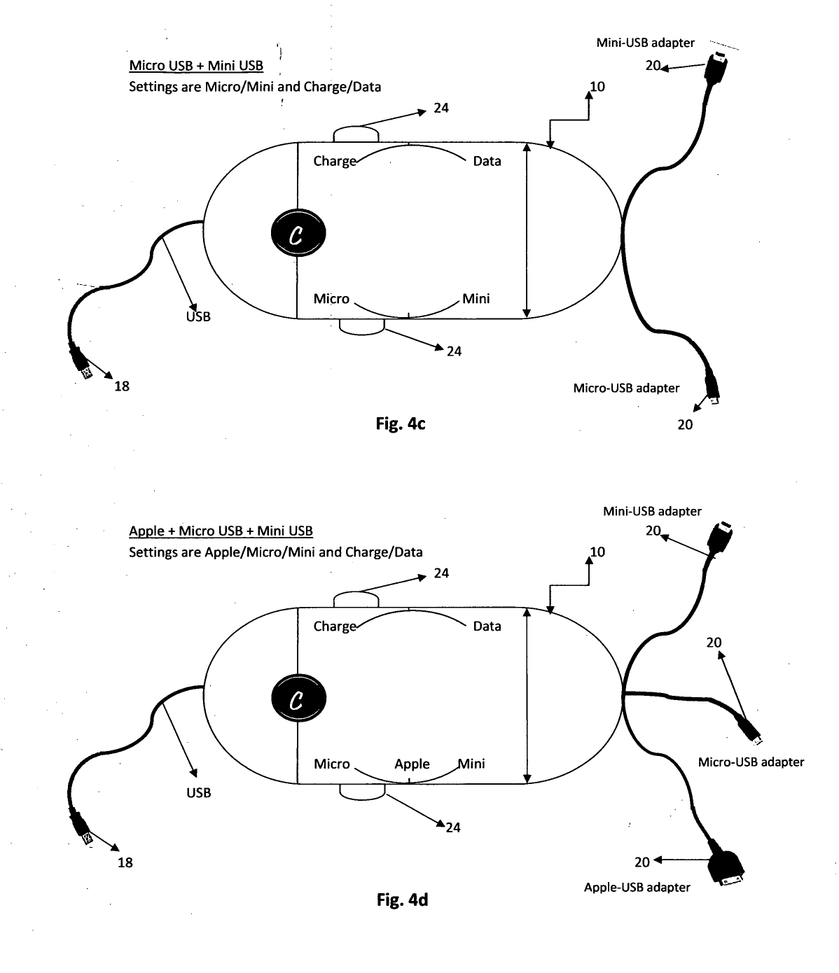

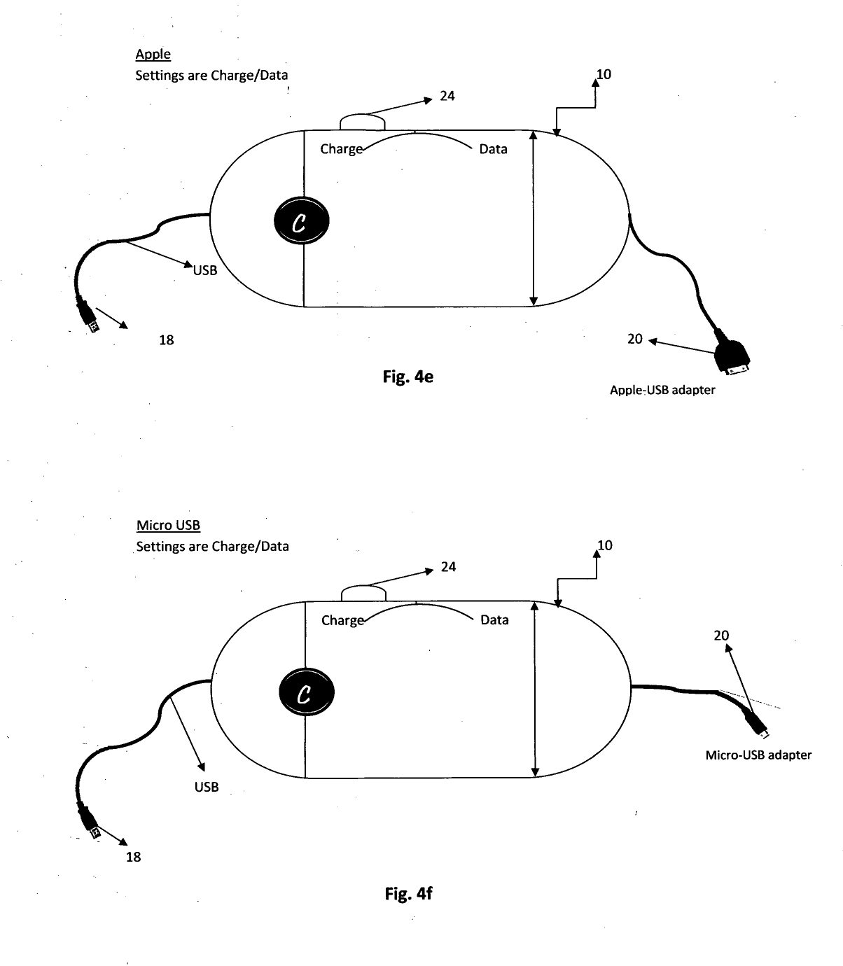

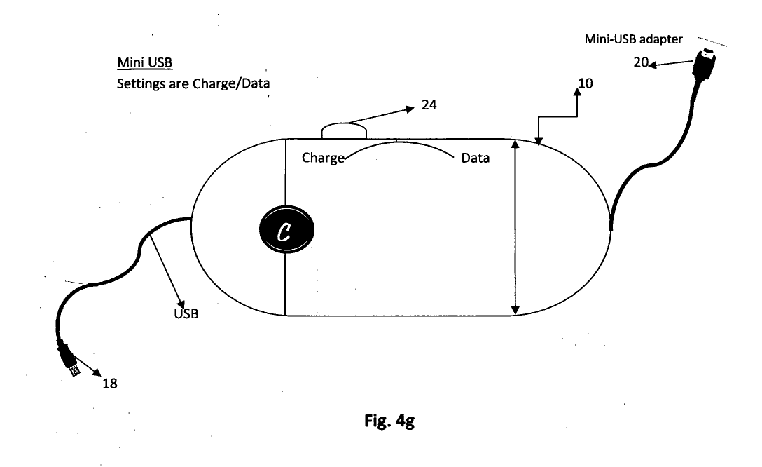

The charging apparatus 10 may be modified to charge other PEDs which require other jacks instead of the USB A-type jack 20. In particular, the USB A-type jack 20 may be replaced/added on by mini USB adapters, micro USB adapters and Apple adapters as shown in FIGS. 4a to 4d. Such modifications allow multiple PEDs to be charged using the same charging apparatus 10.

It should be appreciated by the person skilled in the art that the invention is not restricted to the embodiment described above. Variations and modifications to the invention may be incorporated to create new embodiments. Such variations and modifications include the following:
The physical implementation may take many forms−captive/removable cables, different connectors (USB, mini-USB, micro USB, custom)
Extra features such as AC to DC power convertor may be adapted into the charger for the provision of wall-plug charging.
The DPDT switch 22, 26 may be removed and be replaced by analog switches or relays as known to a person skilled in the art. For example, the DPDT switch 26 may be replaced by a small signal MOSFET.
The manual switch 24 may be removed and replaced by an automatic switch.
Additional manual switches 24 and internal DPDT switches 22, 26 may be added to the charging apparatus 10 for multiple PEDs to be charged using the same charging apparatus 10.
The electrical input at V_{cc} may be regulated at the desired voltage by means of any suitable voltage regulator configurations as known to a person skilled in the art.
The USB-A plug 18 may be replaced with a mains power converter for the purposes of charging multiple PEDs sequentially. However, this version will not be capable of data transfer/synchronization since it is connected to the wall adapter. In this situation, the circuit shown in FIG. 2 is modified such that DPDT switch 22 is removed, and the Apple connector would connect directly to the pin NO1 176 and pin NO2 178 on DPDT switch 26, thereby tapping point 63 and point 67 of the resistor bias network respectively. The Mini-USB/micro USB cable would connect directly to the pin NC1 172 and pin NC2 174.

What is claimed is:

1. An apparatus comprising:
at least one USB adapter, the USB adapter being configured to be electrically connected to a USB port of a gadget;
at least one charging adapter, the charging adapter configured to be electrically connected to a Portable Electronic Device (PED);
at least one internal switch and at least one manual switch;
wherein the apparatus is a smart apparatus which recognizes a portable electronic device electrically connected to it without alteration or installation of a software or hardware component of the gadget for device recognition.

2. The apparatus as claimed in claim 1, wherein the apparatus charges the portable electronic device in active or standby mode of the gadget.

3. The apparatus as claimed in claim 1, wherein the apparatus charges one portable electronic device at a time.

4. The apparatus as claimed in claim 1, wherein the at least one internal switch is configured such that it switches between at least one charging mode and a data transfer mode according to the position of the manual switch.

5. The apparatus as claimed in claim 1, wherein the gadget is a machine having power and a USB port.

6. The apparatus as claimed in claim 1, wherein the gadget is a computing machine.

7. The apparatus as claimed in claim 1, wherein method of charging Portable Electronic Device (PED) via the apparatus comprises: generating a charger output having a regulated voltage and a maximum current capacity; generating a charger configuration signal having pre-selected characteristics, the characteristics including a pre-selected voltage level or shorting of connections; and coupling the charger output and charger configuration signal to the electronic device via a Universal Serial Bus (USB) port on the electronic device, wherein the electronic device is configured to identify the values of the regulated voltage and maximum current capacity of the charger output from the pre-selected voltage level or shorting of connections of the charger configuration signal and to apply the charger output to recharge the PED.

8. A method of Portable Electronic Device (PED) recognition by a power source, the method comprising mediating an electronic transaction between the PED and the power source, by a charging apparatus, wherein the charging apparatus comprises:
at least one USB adapter, the USB adapter being configured to be electrically connected to a USB port of a power source;
at least one charging adapter, the charging adapter configured to be electrically connected to a portable electronic device;
at least one internal switch and at least one manual switch;
wherein the power source has a USB output.

9. The method as claimed in claim 8, wherein the power source is a gadget or a wall power source.

10. The method as claimed in claim 8, wherein the power source is a computing machine.

11. The method as claimed in claim 8, wherein the at least one internal switch is configured such that it switches between at least one charging mode and a data transfer mode according to the position of the manual switch.

12. The apparatus as claimed in claim 1, wherein the apparatus charges one portable electronic device at a time.

13. A wall power charging apparatus comprising:
a wall adapter that can charge at least two devices sequentially;
at least two charging adapters, the charging adapter configured to be electrically connected to the Portable Electronic Device (PED).

14. The wall power charging apparatus as claimed in claim 13, wherein the wall charger has at least one internal switch and at least one manual switch.

15. The wall power charging apparatus as claimed in claim 13, wherein the wall charger charges one device at a time.

16. The wall power charging apparatus as claimed in claim 14, wherein the wall charger provides emulation between functions of the internal switch.
